(19) United States
(12) Patent Application Publication
(10) Pub. No.: US 2012/0099142 A1
(43) Pub. Date: Apr. 26, 2012

(54) OPERATING DEVICE AND IMAGE FORMING APPARATUS

(75) Inventors: Maki MIKAWA, Yokohama-shi (JP); Kana IGURA, Yokohama-shi (JP); Hiroko SAITO, Yokohama-shi (JP); Tomotaka NAGAO, Yokohama-shi (JP)

(73) Assignee: FUJI XEROX CO., LTD., Tokyo (JP)

(21) Appl. No.: 13/103,604

(22) Filed: May 9, 2011

(30) Foreign Application Priority Data
Oct. 22, 2010 (JP) 2010-237319

(51) Int. Cl. G06K 15/00; G09G 5/00

(52) U.S. Cl. 358/1.15; 345/156

(57) ABSTRACT

An operating device to operate an electronic device, includes: a display that displays a status of the electronic device; an execution part that restarts an operation of the electronic device; and a stoppage part that stops the operation of the electronic device, the display and the execution part being provided as a group, and the stoppage part being provided away from the display and the execution part.

### CROSS-REFERENCE TO RELATED APPLICATION

This application is based on and claims priority under 35 USC 119 from Japanese Patent Application No. 2010-237319 filed Oct. 22, 2010.

### BACKGROUND

### Technical Field

The present invention relates to an operating device and an image forming apparatus.

### SUMMARY

According to an aspect of the present invention, there is provided an operating device to operate an electronic device, including: a display that displays a status of the electronic device; an execution part that restarts an operation of the electronic device; and a stoppage part that stops the operation of the electronic device, the display and the execution part being provided as a group, and the stoppage part being provided away from the display and the execution part.

### BRIEF DESCRIPTION OF THE DRAWINGS

An exemplary embodiment of the present invention will be described in detail based on the following figures, wherein:

FIG. 1 is a perspective view of an image forming apparatus according to an exemplary embodiment of the present invention;

FIG. 2 is a cross-sectional view of the image forming apparatus according to the exemplary embodiment of the present invention viewed from a side surface;

FIG. 3 schematically shows an operating device according to the exemplary embodiment of the present invention;

FIG. 4 is a cross-sectional view along a line A-A in FIG. 3;

FIG. 5 is a block diagram showing a functional configuration of the image forming apparatus according to the exemplary embodiment of the present invention;

FIGS. 6A to 6D are explanatory views of an operation of a display upon exhaustion of recording medium; and

FIGS. 7A to 7D are explanatory views of an operation of the display upon exhaustion of toner in a container.

### DETAILED DESCRIPTION

An exemplary embodiment of the present invention will be described based on the drawings.

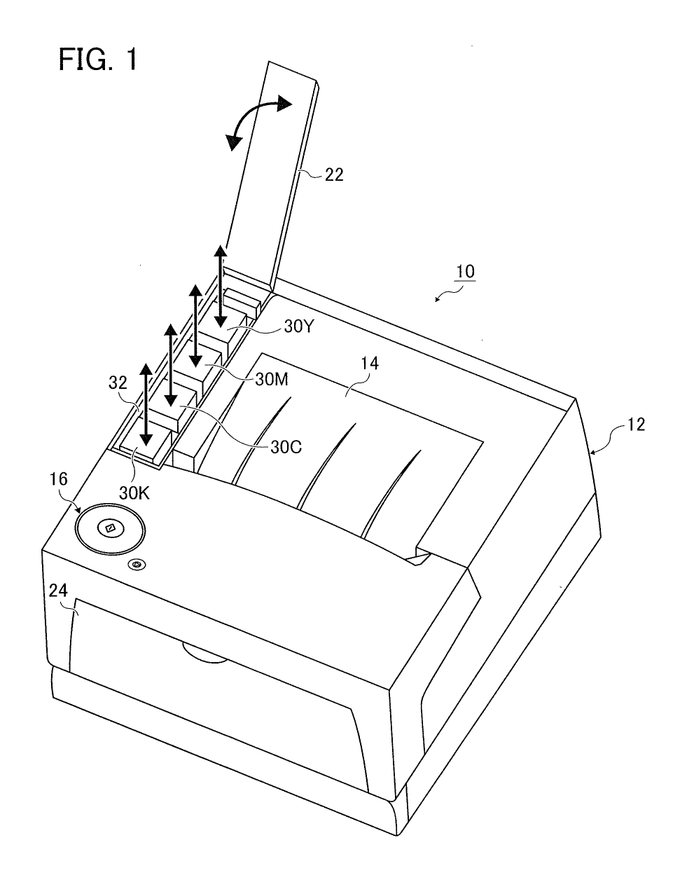

FIG. 1 is a perspective view of an image forming apparatus 10 according to an exemplary embodiment of the present invention.

The image forming apparatus 10 has a case body 12. An upper part of the case body 12 is used as a discharge part 14 to which an image-formed recording medium is discharged.

An operating device 16 is provided on the front side of the case body 12.

The case body 12 is provided with an attachment opening/closing part 22 and a paper-feed opening/closing part 24 respectively openably/closably with respect to the case body 12. An attachment device 32 to which containers 30Y, 30M, 30C and 30K are attached is provided in the case body 12.

The attachment opening/closing part 22 is opened when the containers 30Y, 30M, 30C and 30K used as image forming agent containers are attached in the case body 12 or when the containers 30Y, 30M, 30C and 30K are removed from the case body 12. Further, the attachment opening/closing part 22 is closed when an image is formed.

Note that in the exemplary embodiment, the opening/closing of the attachment opening/closing part 22 is made by rotation about a rear part of the case body 12 (a support point is formed on the side of a shorter side of the attachment opening/closing part 22); however, the present invention is not limited to this arrangement, and rotation may be made about a side part of the case body 12 (a support point is formed on the side of a longer side of the attachment opening/closing part 22).

The paper-feed opening/closing part 24 is opened when recording media are supplied from the front side of the case body 12.

The containers 30Y, 30M, 30C and 30K respectively contain yellow (Y), magenta (M), cyan (C) and black (K) toner used as image forming agents.

The containers 30Y, 30M and 30C respectively have the same shape and size and contain approximately the same volume of toner.

The container 30K has a shape longer than the containers 30Y, 30M and 30C, and has a capacity larger than that of the containers 30Y, 30M and 30C so as to contain toner in a larger volume than that of these containers 30Y, 30M and 30C.

Although the containable volume of toner of the containers 30Y, 30M and 30C is different from that of the container 30K, the constituent elements and functions are the same.

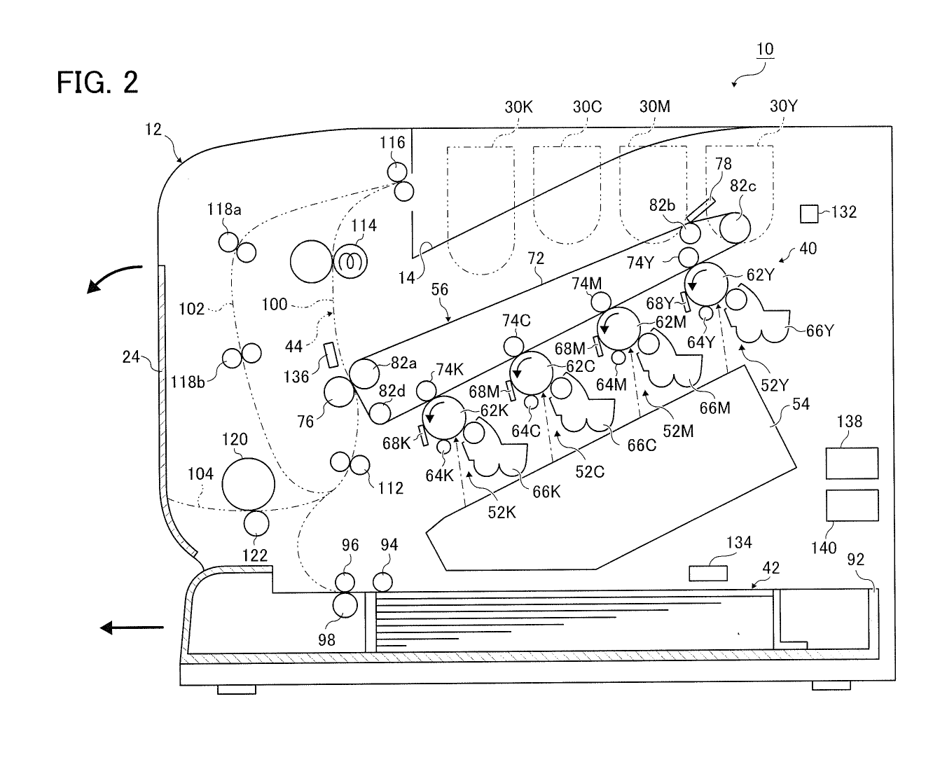

FIG. 2 is a cross-sectional view of the image forming apparatus 10 viewed from a side surface.

An image forming part 40, a recording medium supply device 42 to supply a recording medium to the image forming part 40, and a conveyance passage 44 used for conveyance of the recording medium are provided in the case body 12.

The image forming part 40, the recording medium supply device 42 and the conveyance passage 44 constitute an image forming part that forms an image on a recording medium.

The image forming part 40 has e.g. four image forming units 52Y, 52M, 52C and 52K, a latent image forming device 54 and a transfer device 56. The image forming units 52Y, 52M, 52C and 52K respectively form a developer image using Y, M, C and K toner.

Hereinbelow, generic designation such as an “image forming unit 52” without Y, M, C or K corresponding to each color may be used. Further, generic designation may be similarly used regarding other constituent elements (container 30, a photoreceptor drum 62 and the like).

The image forming unit 52 has a photoreceptor drum 62 used as an image holder, a charging device 64 to charge the photoreceptor drum 62, a developing device 66 to form a toner image by developing an electrostatic latent image formed with a latent image forming device 54 on the surface of the photoreceptor drum 62 using toner, and a cleaning device 68 to clean the surface of the photoreceptor drum 62.

The developing device 66 is supplied with toner in a corresponding color from the container 30.

The transfer device 56 has a belt type intermediate transfer body 72 used as a transfer medium, first transfer rollers 74Y, 74M, 74C and 74K used as first transfer devices, a second transfer roller 76 used as a second transfer device, and a cleaning device 78 to clean the surface of the intermediate transfer body 72.

Toner images formed on the respective photoreceptor drums 62 are overlap-transferred on the intermediate transfer body 72. The intermediate transfer body 72 is rotatably supported with e.g. four support rollers 82a, 82b, 82c and 82d used as support members.

The first transfer rollers 74Y, 74M, 74C and 74K respectively transfer toner images corresponding to the respective colors formed on the photoreceptor drums 62Y, 62M, 62C and 62K to the intermediate transfer body 72.

The second transfer roller 76 transfers the respective color toner images transferred onto the intermediate transfer body 72 to a recording medium.

The recording medium supply device 42 has a recording medium container 92 to contain recording media in e.g. a stacked state, an extraction roller 94 to extract a top recording medium contained in the recording medium container 92, a conveyance roller 96 to convey the recording medium extracted with the extraction roller 94 toward the image forming part 40, and a separation roller 98, in contact with the conveyance roller 96, to separate the recording medium between the conveyance roller 96 and the separation roller 98.

The recording medium container 92 can be pulled out to e.g. the front side (left side in FIG. 2) of the case body 12, and is replenished with the recording media when pulled out from the case body 12.

The conveyance passage 44 has a main conveyance passage 100, a reversing conveyance passage 102 and an auxiliary conveyance passage 104.

The main conveyance passage 100 is a conveyance passage for conveyance of a recording medium supplied from the recording medium supply device 42 toward the discharge part 14. In the main conveyance passage 100, a registration roller 112, the second transfer roller 76, a fixing device 114, and a discharge roller 116 are arranged sequentially from the upstream side in a recording medium conveyance direction.

The registration roller 112 starts to rotate at predetermined timing from a stopped status, to supply a recording medium to a contact portion between the intermediate transfer body 72 and the second transfer roller 76, in accordance with timing of transfer of a toner image to the intermediate transfer body 72.

The fixing device 114 fixes the toner image, transferred with the transfer device 56 on the recording medium, to the recording medium.

The discharge roller 116 discharges the recording medium, on which the toner image has been fixed with the fixing device 114, to the discharge part 14. Further, in a case where images are formed on the both surfaces of a recording medium, the discharge roller 116 rotates in an opposite direction to a direction when discharging the recording medium to the discharge part 14, to convey the recording medium, where an image is formed on one surface, from the rear end side to the reversing conveyance passage 102.

The reversing conveyance passage 102 is used for reversing the recording medium with the image formed on the one surface, and conveyance of the recording medium toward the upstream side of the registration roller 112. In the reversing conveyance passage 102, e.g. two reverse conveyance rollers 118a and 118b are provided.

The auxiliary conveyance passage 104 is used when a recording medium is supplied from the front side of the case body 12 in a status where the paper-feed opening/closing part 24 is opened with respect to the case body 12. In the auxiliary conveyance passage 104, an auxiliary conveyance roller 120 to convey the recording medium toward the registration roller 112 and a separation roller 122 in contact with the auxiliary conveyance roller 120 for separation of the recording medium are provided.

In the case body 12, an image forming agent detector 132 to detect the attached/non-attached status of the container 30 and the amount of toner contained in the container 30, a recording medium detector 134 to detect the presence/absence of a recording medium contained in the recording medium container 92, and a conveyance detector 136 to detect a recording medium conveyance abnormality (e.g. jam) in the conveyance passage 44 are provided.

The image forming agent detector 132, the recording medium detector 134, and the conveyance detector 136 constitute a detection unit that detects an operation status of the image forming part.

Further, a driving device 138 to drive the recording medium conveyance members such as the registration roller 112 and the members constituting the image forming part 40 such as the developing device 66, and a controller 140 used as a controller that controls the respective elements constituting the image forming apparatus 10 are provided in the case body 12.

The controller 140 is notified of respective detection results from the image forming agent detector 132, the recording medium detector 134 and the conveyance detector 136.

In the exemplary embodiment, the apparatus statuses of the image forming apparatus 10 include an abnormal status, a stopped status and a normal status.

In the abnormal status, an image cannot be normally formed. More particularly, the container 30 is not attached, or the container 30 contains no toner, or the recording medium container 92 contains no recording medium, or recording-medium jam has occurred in the middle of conveyance.

In the stopped status, the image forming apparatus 10 is stopped for saving of electric power consumption (sleep mode).

In the normal status, which is neither the abnormal status nor the stopped status, an image can be normally formed on a recording medium.

Note that the apparatus statuses are not limited to these statuses, and the statuses may be arbitrarily changed in accordance with usage.

Next, the details of the operating device 16 will be described.

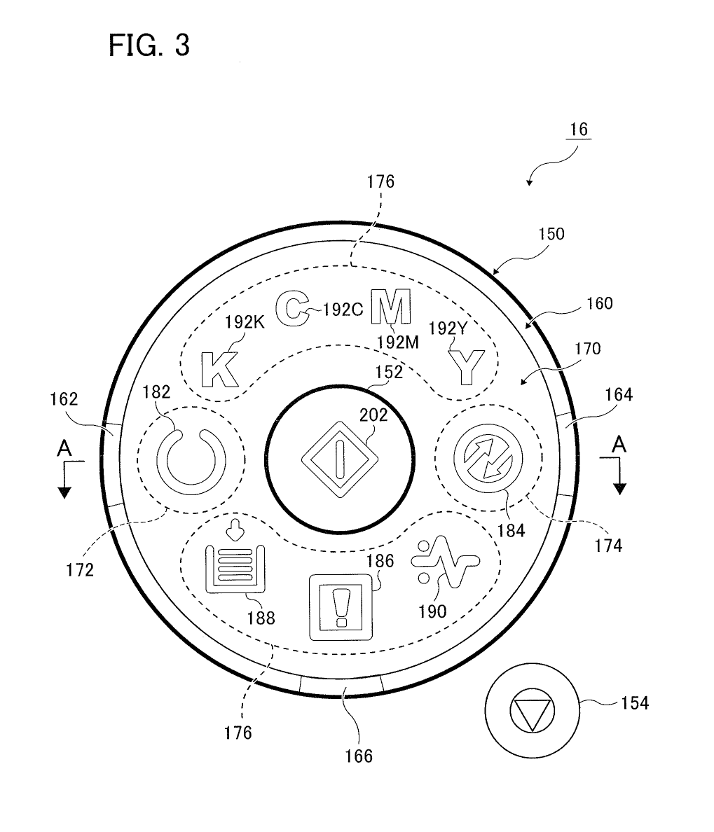

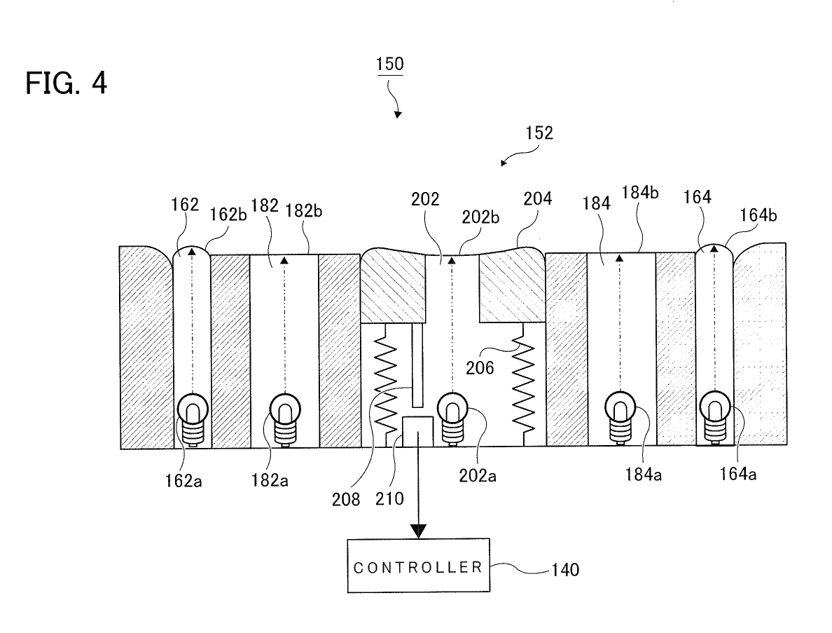

FIG. 3 schematically shows the operating device 16. FIG. 4 is a cross-sectional view along a line A-A in FIG. 3.

The operating device 16 has a display 150, an execution depression part 152 used as an executing part, and a stoppage depression part 154 used as a stopping part.

The display 150 has a ring-shaped outer display 160 as a first display, and an inner display 170 formed inside the outer display 160 as a second display.

The outer display 160 is provided with a first light 162, a second light 164 and a third light 166.

The first light 162 is turned on when the image forming apparatus 10 is in the normal status.

The second light 164 is turned on when the image forming apparatus 10 is in the stopped status.

The third light 166 is turned on when the image forming apparatus 10 is in the abnormal status.

The inner display 170 is provided with more lights (nine in the exemplary embodiment) than the lights (three in the exemplary embodiment) provided in the outer display 160.

The lights of the inner display 170 have shapes of characters and figures to indicate the operation statuses of the respective parts in the apparatus statuses indicated with the lights of the outer display 160.

That is, the lights of the inner display 170 indicate more detailed operation statuses in comparison with the apparatus statuses indicated with the lights of the outer display 160.

In the exemplary embodiment, the operation statuses of the respective parts of the image forming apparatus 10 indicate e.g. whether or not toner is normally supplied (whether or not the container 30 is attached or whether or not the container 30 contains toner), whether or not the recording medium container 92 contains recording media, and whether or not the recording medium is normally conveyed.

Note that the operation statuses are not limited to these statuses and may be arbitrarily changed in accordance with usage.

The inner display 170 is sectionalized as a first region 172 corresponding to the first light 162, a second region 174 corresponding to the second light 164 and a third region 176 corresponding to the third light 166.

More particularly, when the light provided in the first region 172 is turned on, the first light 162 is turned on; when the light provided in the second region 174 is turned on, the second light 164 is turned on; and when the light provided in the third region 176 is turned on, the third light 166 is turned on.

In this manner, the light (any of the first light 162, the second light 164 and the third light 166) in the outer display 160 is set to be turned on in correspondence with each of the lights in the inner display 170.

The first region 172, the second region 174 and the third region 176 are provided in the vicinity of the corresponding first light 162, the second light 164 and the third light 166 or on the same straight line. Accordingly, in comparison with a case without the present structure, the user is easily reminded of the lights of the inner display 170 in correspondence with the lights of the outer display 160.

A normal status light 182, which is turned on when the image forming apparatus 10 is in the normal status, is provided as a light in the first region 172.

A stopped status light 184, which is turned on when the image forming apparatus 10 is in the stopped status, is provided as a light in the second region 174.

An abnormality occurrence light 186, which is turned on when the image forming apparatus 10 is in the abnormal status, is provided as a light in the third region 176.

Further, a recording medium exhaustion light 188, which is turned on when the recording medium container 92 contains no recording medium, a conveyance abnormality light 190, which is turned on when an abnormality occurs in recording medium conveyance (e.g. jam), and image forming agent abnormality lights 192Y, 192M, 192C and 192K, which are turned on when an abnormality occurs in toner supply from the containers 30Y, 30M, 30C and 30K, are provided in the third region 176.

The image forming agent abnormality lights 192Y, 192M, 192C and 192K are respectively turned on when the corresponding containers 30Y, 30M, 30C and 30K are not attached and when contained toner runs out, and flash on and off when the amounts of remaining toner are small (e.g. the amounts of remaining toner are smaller than 20% of the maxim volume).

Note that for the sake of user convenience, it may be arranged such that marks in corresponding colors are attached in the vicinity of the image forming agent abnormality lights 192Y, 192M, 192C and 192K.

The recording medium exhaustion light 188, the conveyance abnormality light 190 and the image forming agent abnormality lights 192Y, 192M, 192C and 192K indicate the contents of abnormality statuses more concretely than the lights of the outer display 160.

In this manner, the display 150 integrally displays the operation statuses of the image forming apparatus 10 in layers (two-stage structure in the exemplary embodiment).

As shown in FIG. 4, the first light 162 has a light source 162a such as an LED (Light Emitting Diode), and a transmission part 162b of a transparent material to transmit light. The transmission part 162b has a convex shape.

In the outer display 160, a second light 164 and a third light 164 have the same shape as that of the first light 162.

The normal status light 182 has a light source 182a such as an LED and a transmission part 182b of a transparent material to transmit light.

In the inner display 170, the stopped status light 184, the abnormality occurrence light 186, the recording medium exhaustion light 188, the conveyance abnormality light 190, and the image forming agent abnormality lights 192Y, 192M, 192C and 192K have the same structure as that of the normal status light 182.

The transmission part (transmission part 162b or the like) of the outer display 160 is higher than (projected from) the transmission part (transmission part 182b) of the inner display 170. Accordingly, in comparison with a case without the present structure, the display with the outer display 160 is more visible for a user than the display with the inner display 170.

For example, in the display 150, only lighting of the outer display 160 is visible but lighting of the inner display 170 is not visible from a distance, while the lighting of the outer display 160 and the lighting of the inner display 170 are visible at a short distance.

Not that it may be arranged such that the intensity, color or the like of light in the outer display 160 is different from that in the inner display 170 and the display with the outer display 160 is more visible than the display with the inner display 170.

The execution depression part 152 is provided inside the inner display 170 in the display 150, integrally with the display 150. The display 150 and the execution depression part 152 form a group with the outer display 160 as a boundary.

The execution depression part 152 is used for execution of operations of the respective constituent elements of the image forming apparatus 10. For example, the execution depression part 152 is depressed when executing a preparatory operation (recovery operation) to restore the normal status from the abnormality status.

The preparatory operation means, when, e.g. recording media have been replenished to the recording medium container 92, an operation to convey (feed) a recording medium to a desired position, or after attachment of the container 30, an operation to replenish toner to the developing device 66.

The execution depression part 152 is provided with an execution light 202. The execution light 202 is turned on upon request for execution of the preparatory operation.

The execution light 202 has a light source 202a such as an LED and a transmission part 202b of a transparent material to transmit light.

The execution depression part 152 is provided with a depression member 204 depressed by the user, a pressing member 206 such as a spring to press the depression member 204 upward, a contact member 208 provided integrally with the depression member 204, and a designation member (switch) 210 connected to the controller 140.

When the user depresses the depression member 204, the contact member 208 pushes the designation member 210 against the pressing force of the pressing member 206. In the execution depression part 152, as the designation member 210 is pushed with the contact member 208, the controller 140 controls the driving device 138 and the display 150 to perform desired operations.

The stoppage depression part 154 is provided as a separate body from the display 150 and the execution depression part 152. That is, the stoppage depression part 154 is arranged in a position away from the display 150 and the group of the execution depression part 152.

The stoppage depression part 154 stops operations of the constituent elements of the image forming apparatus 10. For example, the stoppage depression part 154 is depressed upon stoppage of image formation in the middle.

Next, the functional configuration of the image forming apparatus 10 will be described.

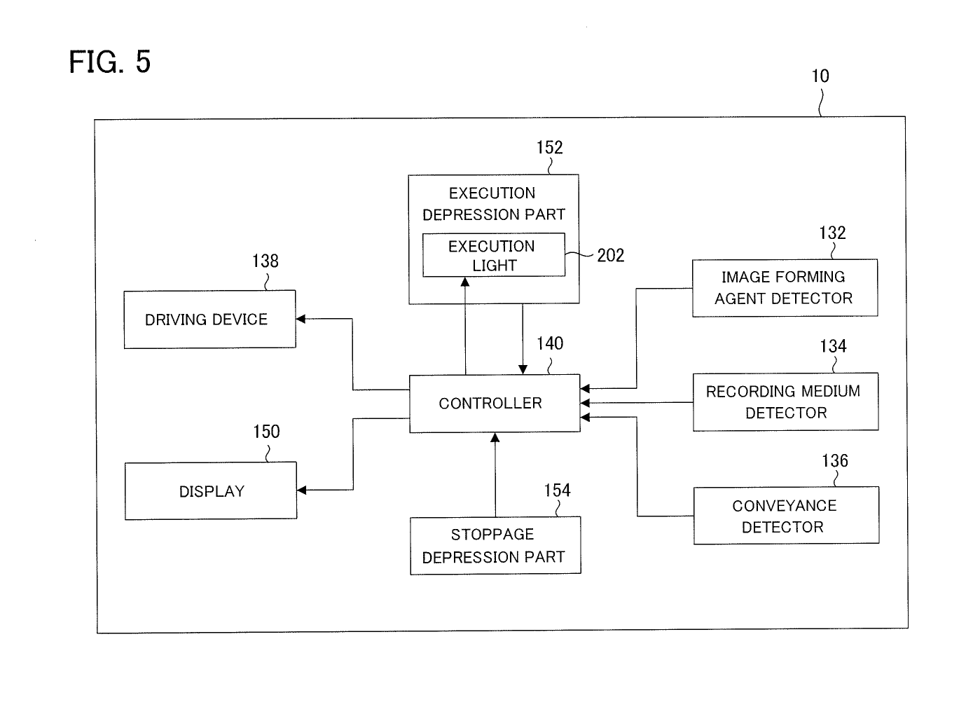

FIG. 5 is a block diagram showing the functional configuration of the image forming apparatus 10.

When the execution depression part 152 or the stoppage depression part 154 is depressed, the controller 140 operates or stops the driving device 138 or controls the display 150 to display the corresponding operation status based on the depression.

Further, based on the result of detection with the image forming agent detector 132, the recording medium detector 134 or the conveyance detector 136, the controller 140 controls the display 150 to display the corresponding status.

Next, the operation of the operating device 16 will be described.

First, as an example, the operation when the recording medium contained in the recording medium container 92 runs out will be described.

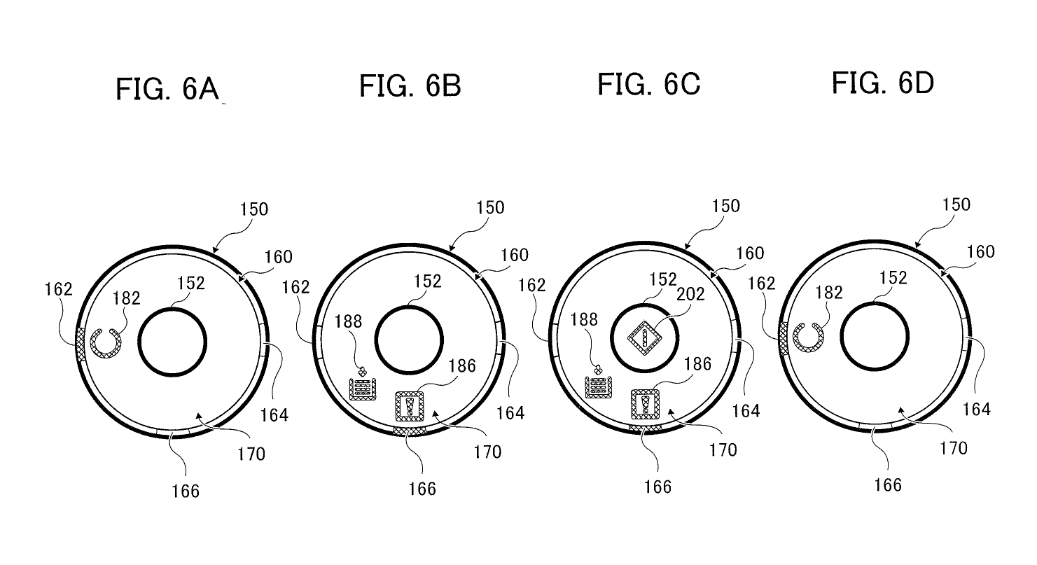

FIGS. 6A to 6D are explanatory views of the operation of the display 150 when a recording medium is exhausted.

When the recording medium container 92 contains recording media (normal status), the controller 140 turns on the normal status light 182 of the inner display 170 in the display 150 and the first light 162 of the outer display 160 indicating the normal status set with respect to the normal status light 182 (FIG. 6A).

When there is no recording medium in the recording medium container 92, the recording medium detector 134 detects that there is no recording medium and notifies the controller 140 of the exhaustion of the recording medium.

When the controller 140 receives the result of detection that there is no recording medium from the recording medium detector 134, the controller 140 turns on the abnormality occurrence light 186 and the recording medium exhaustion light 188 of the inner display 170, and the third light 166 of the outer display 160 to indicate the abnormal status set with respect to the abnormality occurrence light 186 (FIG. 6B).

When the recording media are replenished to the recording medium container 92, the recording medium detector 134 detects that there are recording media, and notifies the controller 140 of the existence of the recording media.

When the controller 140 receives the result of detection that there are recording media from the recording medium detector 134, the controller 140 turns on the execution light 202 of the execution depression part 152, in addition to lighting of the abnormality occurrence light 186 and the recording medium exhaustion light 188 of the inner display 170 and lighting of the third light 166 of the outer display 160 (FIG. 6C).

In this case, when the execution depression part 152 is depressed, the controller 140 controls the driving device 138 to perform the preparatory operation.

When the preparatory operation is completed, the image forming apparatus 10 goes into the normal status, and the controller 140 turns on the normal status light 182 of the inner display 170 and the first light 162 of the outer display 160 indicating the normal status set with respect to the normal status light 182 (FIG. 6D).

Next, as an example, an operation when toner contained in the container 30M is exhausted will be described.

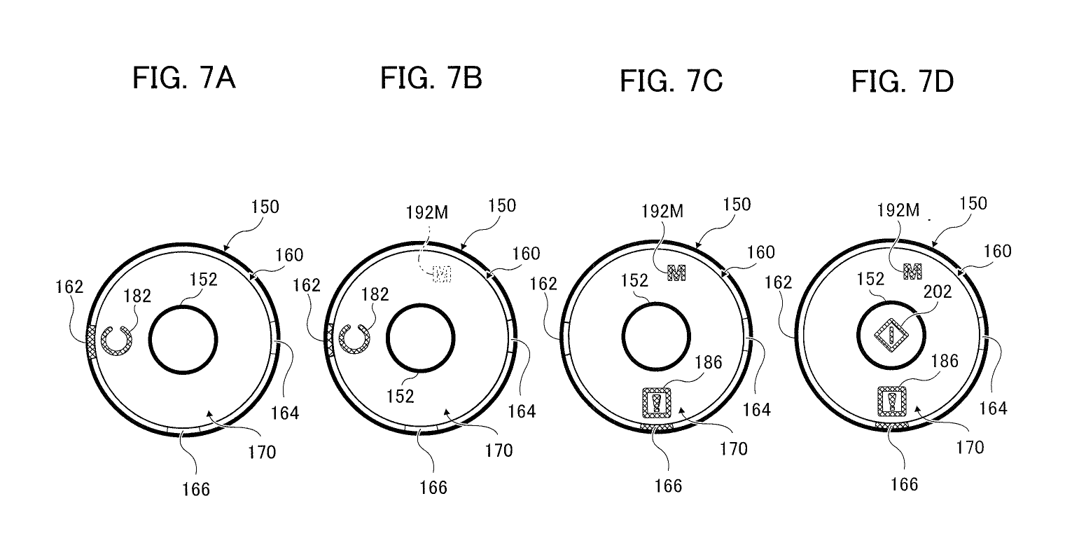

FIGS. 7A to 7D are explanatory views of the operation of the display 150 upon exhaustion of toner in the container 30M.

When toner is sufficiently (e.g., 20% of the maximum capacity or higher) contained in the container 30M (normal status), the controller 140 turns on the normal status light 182 of the inner display 170 in the display 150 and the first light 162 of the outer display 160 indicating the normal status set with respect to the normal status light 182 (FIG. 7A).

When the amount of remaining toner contained in the container 30M is small (e.g., when the amount of remaining toner is lower than 20% of the maximum capacity), the image forming agent detector 132 detects that the amount of toner is small, and notifies the controller 140 of the shortage of the toner.

When the controller 140 receives the result of detection that the amount of toner is small from the image forming agent detector 132, the controller 140 causes the image forming agent abnormality light 192M to flash on and off, in addition to lighting of the normal status light 182 of the inner display 170 and the first light 162 of the outer display 160 (FIG. 7B).

When the toner contained in the container 30M runs out, the image forming agent detector 132 detects there is no toner, and notifies the controller 140 of the exhaustion of the toner.

When the controller 140 receives the result of detection that there is no toner from the image forming agent detector 132, the controller 140 turns the abnormality occurrence light 186 and the forming agent abnormality light 192M of the inner display 170 and the third light 166 of the outer display 160 to indicate the abnormal status set with respect to the abnormality occurrence light 186 (FIG. 7C).

When toner is replenished to the container 30M (new container 30M is attached), the image forming agent detector 132 detects that there is toner, and notifies the controller 140 of the existence of the toner.

When the controller 140 receives the result of detection that there is one recording medium from the recording medium detector 134, the controller 140 turns on the execution light 202 of the execution depression part 152, in addition to lighting of the abnormality occurrence light 186 and the image forming agent abnormality light 192M of the inner display 170 and the third light 166 of the outer display 160 (FIG. 7D).

In this case, when the execution depression part 152 is depressed, the controller 140 controls the driving device 138 to perform the preparatory operation.

When the preparatory operation is completed, the image forming apparatus 10 goes into the normal status, and the controller 140 turns on the normal status light 182 of the inner display 170 and the first light 162 of the outer display 160 to indicate the normal status set with respect to the normal status light 182 (FIG. 7A).

In the above-described exemplary embodiment, the outer display 160 of the display 150 has a ring shape; however, the shape is not limited to this shape and may be another shape such as a square shape. Further, the number, the shape, the contents and the like of the lights of the outer display 160 and the inner display 170 can be arbitrarily changed in accordance with application.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An operating device to operate an electronic device, comprising:
a display that displays a status of the electronic device;
an execution part that restarts an operation of the electronic device; and
a stoppage part that stops the operation of the electronic device,
the display and the execution part being provided as a group, and
the stoppage part being provided away from the display and the execution part.

2. The operating device according to claim 1,
wherein the display has a plurality of lights that respectively display a plurality of statuses, and
the plurality of lights are provided around the execution part.

3. The operating device according to claim 1, wherein the display has:
a ring-shaped first display forming boundary of the group; and
a second display provided inside the first display.

4. The operating device according to claim 2, wherein the display has:
a ring-shaped first display forming boundary of the group; and
a second display provided inside the first display.

5. The operating device according to claim 3,
wherein the first display and the second display respectively have a plurality of display lights, and
the operating device further comprises:
a detection unit that detects an operation status; and
a controller that controls the display light of the second display and the display light of the first display previously determined with respect to the display light of the second display, based on a result of detection by the detection unit.

6. The operating device according to claim 4,
wherein the first display and the second display respectively have a plurality of display lights, and
the operating device further comprises:
a detection unit that detects an operation status; and
a controller that controls the display light of the second display and the display light of the first display previously determined with respect to the display light of the second display, based on a result of detection by the detection unit.

7. The operating device according to claim 5,
wherein the execution part has an execution light, and
when executing the operation, the controller turns on the execution light.

8. The operating device according to claim 6,
wherein the execution part has an execution light, and
when executing the operation, the controller turns on the execution light.

9. An image forming apparatus comprising:
an image forming unit that forms an image on a recording medium;
a display that displays a status of the image forming unit;
an execution part that restarts an operation of the image forming unit; and
a stoppage part that stops the operation of the image forming unit,
the display and the execution part being provided as a group, and
the stoppage part being provided away from the display and the execution part.
